(19) United States
(12) Patent Application Publication
(10) Pub. No.: US 2016/0069109 A1
(43) Pub. Date: Mar. 10, 2016

(54) Deadbolt Reinforcement Device

(71) Applicant: Amy B. Vaughan, Jacksonville, FL (US)

(72) Inventor: Amy B. Vaughan, Jacksonville, FL (US)

(21) Appl. No.: 14/480,813

(22) Filed: Sep. 9, 2014

(51) Int. Cl. E05C 19/18

(52) U.S. Cl. CPC E05C 19/188

(57) ABSTRACT

According to one embodiment, a deadbolt reinforcement device may include an elongate shaft having a first end and a second end. The deadbolt reinforcement device may further include a clamp head coupled to the first end of the shaft and including a first clamp arm and a second clamp arm. The first clamp arm and the second clamp arm may have compressible engagement surfaces, and the clamp head may be selectively rotatable with respect to the shaft. The deadbolt reinforcement device may also include an actuator operatively coupled to the clamp head. The actuator may be configured to move the first clamp arm toward the second clamp arm to grip a deadbolt turnable handle between the compressible engagement surfaces.

### TECHNICAL FIELD

The present disclosure relates to a security device to reinforce and retain a deadbolt in a locked position on a door.

### BACKGROUND

Many residential entry doors are provided with both a door opening handle (such as a doorknob) and a deadbolt. The deadbolt is typically operated using a simple deadbolt turnable handle (such as a thumb turn) from the inside of the door, and is key-operated from the outside of the door. While the deadbolt provides added security against forced entry, there may be various situations where it is desirable to reinforce the deadbolt. As an example, it may be desirable to reinforce the deadbolt when a person does not know who else may have a key to the deadbolt (such as may be the case with a short-term rental, hotel, corporate housing, and/or turnkey situations). As another example, it may be desirable to reinforce the deadbolt when a person wants to prevent unwanted entry through the door by others who may have a key (such as employees at a hotel), when the person wants to prevent entry through a door at unauthorized times (or unannounced times) by a real estate agent who has access to a key from a lock box, and/or when the person wants to further secure the door from potential intruders who have, for example, a bump key (or some other device for opening doors). As a further example, some entry doors have windows in and/or near the door that could be broken to allow an intruder access to the deadbolt turnable handle. Unfortunately, traditional devices for securing a deadbolt may be insufficient for securing the many different types of deadbolt/door handle configurations that may exist.

### SUMMARY

According to one embodiment, a deadbolt reinforcement device may include an elongate shaft having a first end and a second end. The deadbolt reinforcement device may further include a clamp head coupled to the first end of the shaft and including a first clamp arm and a second clamp arm. The first clamp arm and the second clamp arm may have compressible engagement surfaces, and the clamp head may be selectively rotatable with respect to the shaft. The deadbolt reinforcement device may also include an actuator operatively coupled to the clamp head. The actuator may be configured to move the first clamp arm toward the second clamp arm to grip a deadbolt turnable handle between the compressible engagement surfaces. Furthermore, the second end of the shaft may be optionally configured to be extendable (or may optionally include an extendable portion) to accommodate a plurality of different deadbolt/door handle configurations. Additionally, the deadbolt reinforcement device may further optionally include a rotation locking mechanism configured to selectively lock the rotation of the clamp head with respect to the shaft.

Certain embodiments of the disclosure may provide one or more technical advantages. For example, the deadbolt reinforcement device may include an actuator that may allow the user to tighten the grip on the deadbolt turnable handle as tight as desired. Furthermore, the clamp arms of the deadbolt reinforcement device may each have a compressible engagement surface that is configured to compress (or otherwise deform) when the clamp arms grip the deadbolt turnable handle. As such, in particular embodiments, the clamp arms may securely grip any shape of the deadbolt turnable handle, such as a rectangular shape, oval shape, rhomboid shape, any other shape, or any combination of the preceding. As another example, the shaft may include a second end that may be extended with respect to a first end of the shaft. As such, in particular embodiments, the deadbolt reinforcement device may be able to reinforce a deadbolt that is positioned any distance from the door handle. As a further example, the clamp head may be selectively rotated with respect to the shaft. As such, in particular embodiments, the deadbolt reinforcement device may secure a deadbolt that locks at any position and/or angle of the deadbolt turnable handle, such as horizontal, vertical, or any other angle (such as 45 degrees). In particular embodiments, such adjustability provides a customizability to the deadbolt reinforcement device, and means that a person can buy one device, and then easily use it on different doors while traveling.

Certain embodiments of the disclosure may include none, some, or all of the above technical advantages. One or more other technical advantages may be readily apparent to one skilled in the art from the figures, descriptions, and claims included herein.

### BRIEF DESCRIPTION OF THE FIGURES

For a more complete understanding of the present disclosure and its features and advantages, reference is now made to the following description, taken in conjunction with the accompanying drawings, in which:

FIG. 1A illustrates a front view of a deadbolt reinforcement device according to one embodiment of the disclosure;

FIG. 1B illustrates a back view of the deadbolt reinforcement device of FIG. 1; and

FIG. 1C illustrates a perspective view of the deadbolt reinforcement device of FIG. 1A in position on a door.

### DETAILED DESCRIPTION

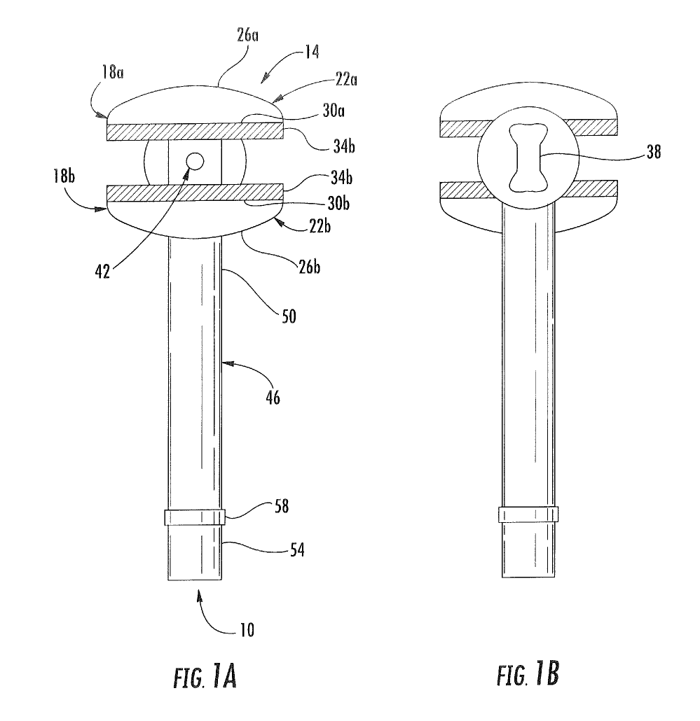

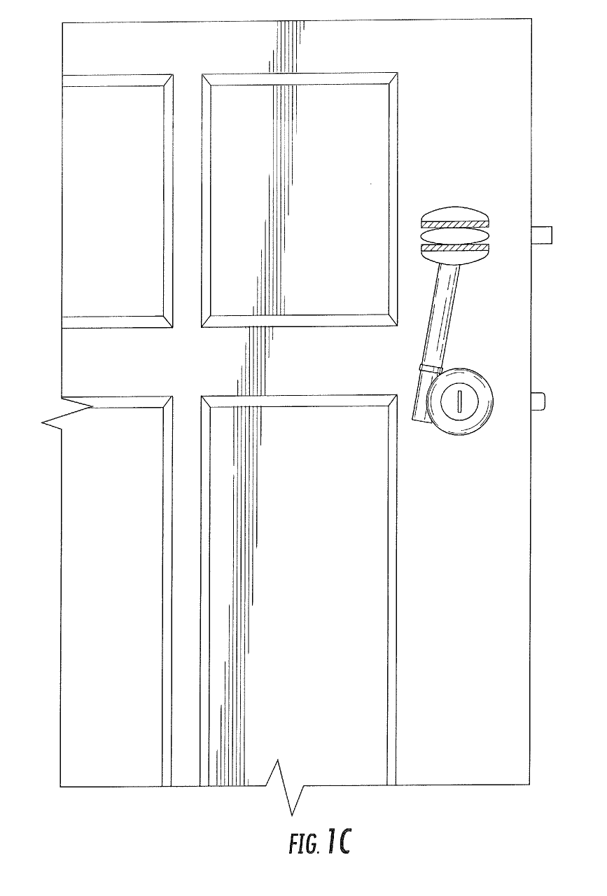

Embodiments of the present disclosure are best understood by referring to FIGS. 1A-1C of the drawings, like numerals being used for like and corresponding parts of the various drawings.

FIGS. 1A-1B illustrate a front and back view of a deadbolt reinforcement device 10 according to one embodiment of the disclosure. Furthermore, FIG. 1C illustrates a perspective view of the deadbolt reinforcement device 10 in position on a door, according to one embodiment of the disclosure. As illustrated, the deadbolt reinforcement device 10 includes a clamp head 14 and a shaft 46. The clamp head 14 includes a first clamp arm 18a and a second clamp arm 18b that may grip (via a clamping motion activated by actuator 38) a deadbolt turnable handle of a deadbolt lock on a door. When positioned on a door (as is seen in FIG. 1C), the deadbolt reinforcement device 10 may prevent the deadbolt of a door from being unlocked, even when the person outside has a key to the deadbolt, in particular embodiments. For example, shaft 46 may be positioned against the door handle of the door. As such, the door handle may prevent shaft 46 from rotating past the door handle. Furthermore, this rotation prevention force (from the door handle) may be transferred from shaft 46 to clamp head 14, and further transferred from clamp head 14 to the deadbolt turnable handle. As such, in particular embodiments, a person outside of the door may no longer be able to unlock the deadbolt, even with a key.

In order to secure a deadbolt of a door, users have previously used various traditional devices. These traditional devices, however, may have a limited configuration that would prevent the device from being used if the deadbolt/door handle configuration is different from that of the device. For example, traditional devices may have hard, straight surfaces for gripping a deadbolt turnable handle. Unfortunately, these traditional devices may not provide a sufficient grip on the deadbolt turnable handle if the deadbolt turnable handle is not straight, such as if the deadbolt turnable handle is oval, rhomboid, or any other shape but straight. As another example, traditional devices may attempt to grip the deadbolt turnable handle by a clamp system that cannot be sufficiently tightened against the deadbolt turnable handle. As a further example, traditional devices may have a limited length, which may prevent them from being used when the deadlock is positioned too far away (or too close) to the door handle.

In particular embodiments, deadbolt reinforcement system 10 of FIGS. 1A-1C may address some (or all) of the above-referenced deficiencies. For example, deadbolt reinforcement device 10 may include an actuator 38 that may allow the user to tighten the grip on the deadbolt turnable handle as tight as desired. Furthermore, clamp arms 18 may each have a compressible engagement surface that is configured to compress (or otherwise deform) when the clamp arms 18 grip the deadbolt turnable handle. As such, in particular embodiments, clamp arms 18 may securely grip any shape of the deadbolt turnable handle, such as a rectangular shape, oval shape, rhomboid shape, any other shape, or any combination of the preceding. As another example, shaft 46 may include a second end 54 that may be extended with respect to a first end 50 of shaft 46. As such, in particular embodiments, deadbolt reinforcement device 10 may be able to reinforce a deadbolt that positioned any distance from the door handle. As a further example, clamp head 14 may be selectively rotated with respect to shaft 46. As such, in particular embodiments, deadlock reinforcement device 10 may secure a deadbolt that locks at any position and/or angle of the deadbolt turnable handle, such as horizontal, vertical, or any other angle (such as 45 degrees).

As is discussed above, deadbolt reinforcement device 10 includes clamp head 14. Clamp head 14 is configured to engage with a deadbolt turnable handle on a door. According to the illustrated embodiment, clamp head 14 includes first clamp arm 18a and second clamp arm 18b. Clamp arms 18 are configured to move toward and away from each other in a clamping motion. As such, clamp arms 18 may securely grip the deadbolt turnable handle. As illustrated, clamp arms 18 each include a rigid portion 22 and further include a compressible engagement surface 34. The rigid portions 22 of the clamp arms 18 may have any suitable size and/or shape. For example, as illustrated, the rigid portions 22 may each have a generally curved outer face 26 and a generally straight inner face 30. Furthermore, the rigid portions 22 may be made of any suitable material, such as metal, a rigid plastic, or any combination of the preceding.

Compressible engagement surfaces 34 are configured to compress (or otherwise deform) when clamp head 14 is engaged with the deadbolt turnable handle on the door. In particular embodiments, such compression may allow clamp head 14 to securely engage with a deadbolt turnable handle having any size and/or shape, such as rectangular, oval, rhomboid, or any other shape. Furthermore, compressible engagement surfaces 34 may prevent slippage from or damage to the deadbolt turnable handle when compressed against the handle surface, in particular embodiments. Compressible engagement surfaces 34 may be formed of silicone, rubber, foam, any other suitable compressible material, or any combination of the preceding. Compressible engagement surfaces 34 may be layered, adhered to, or otherwise provided on the inner faces 30 of rigid portions 22. As such, compressible engagement surfaces 34 may contact the deadbolt turnable handle when clamp head 14 is engaged with deadbolt turnable handle.

Deadbolt reinforcement device 10 further includes actuator 38 operatively coupled to clamp head 14. Actuator 38 is configured to move the first clamp arm 18a closer to (or farther from) the second clamp arm 18b. For example, when a user desires to engage clamp head 14 with the deadbolt turnable handle, the user may activate actuator 38 to cause clamp arms 18 to securely grip (or otherwise clamp onto) the deadbolt turnable handle. As such, clamps arms 18 may have a selectively adjustable distance between each other. Actuator 38 may be any type of mechanism that allows for moving the clamp arms 18 closer to (or farther from) each other. For example, actuator 38 may be a turnable lever, a turnable knob, a button or switch that mechanically or electrically causes movement of one or more of the clamp arms 18, a squeezable (or otherwise configurable) set of grips that cause movement of one or more of the clamp arms 18, any other mechanism for causing movement of one or more of the clamp arms 18, or any combination of the preceding.

Actuator 38 may cause movement in clamp arms 18 in any suitable manner. As an example, actuator 38 may be mechanically coupled (e.g., via screws, springs, or any other mechanical connection) to one or more of clamp arms 18. In such an example, when actuator 38 is activated (such as by a user physically rotating actuator 38 in a clockwise direction, for example), clamp arms 18 may move closer to each other, thereby allowing clamp arms 18 to grip the deadbolt turnable handle. In particular embodiments, this may allow the user to grip the deadbolt turnable handle as tightly as desired by the user. Furthermore, when actuator 38 is deactivated (such as by a user physically rotating actuator 38 in a counterclockwise direction, for example), clamp arms 18 may move farther from each other, thereby releasing the grip on the deadbolt turnable handle. As a further example, actuator 38 may be coupled to one or more of clamp arms 18 in any other manner that may allow actuator 38 to cause movement in clamp arms 18, such as an electrical coupling and/or pneumatic coupling. Actuator 38 may further cause any form of movement in clamp arms 18. For example, actuator 38 may cause movement in only first clamp arm 18a (causing first clamp arm 18a to move closer to or farther from second clamp arm 18b), may cause movement in only second clamp arm 18b (also causing first clamp arm 18a to move closer to or farther from second clamp arm 18b), or may cause movement in both first and second clamp arms 18 (also causing first clamp arm 18a to move closer to or farther from second clamp arm 18b). As another example, actuator 38 may cause a ratcheting-type of movement in clamp arms 18, so that clamp arms 18 move closer to (or father from) each other in small increments. In such an example, actuator 38 (and/or the ratcheting-type movement) may prevent movement of clamp arms 18 in the opposite direction (unless the actuator 38 is released or the direction of movement caused by the actuator 38 is switched).

Actuator 38 may be positioned on (or coupled to) deadbolt reinforcement device 10 in any suitable manner. As an example, actuator 38 may be positioned to be oriented towards the user when clamp head 14 is positioned for engagement with the deadbolt turnable handle (as is seen in FIG. 1B). In such an example, when the user sets up the deadbolt reinforcement device 10 onto the deadbolt turnable handle of a particular door, actuator 38 may oriented away from the door (and thus oriented towards the user). This may allow the user to more easily activate (or deactivate) actuator 38 when the deadbolt reinforcement device 10 is being set up (or taken down).

Actuator 38 and/or deadbolt reinforcement device 10 may further have a clamp arm locking mechanism (not shown). The clamp arm locking mechanism may allow a user to lock the clamp arms 18 in a particular position. For example, once clamp arms 18 are in the desired position (such as in a position to securely grip the deadbolt turnable handle), a user may lock the clamp arms 18 in that position for a duration of time using the clamp arm locking mechanism. This may prevent the clamp arms 18 from moving closer (or farther from) each other. Furthermore, it may further allow clamp arms 18 to lockably compress the compressible engagement surfaces 34 (of clamp arms 18) against the deadbolt turnable handle. The clamp arm locking mechanism may be activated (or otherwise locked) using a button, a toggle switch, or any other device or mechanism for locking the clamp arms 18 in a particular position. Furthermore, actuator 38 and/or deadbolt reinforcement device 10 may also have a clamp arm release mechanism (not shown). The clamp arm release mechanism may allow a user to release the clamp arms 18 from a particular position without requiring the user to deactivate the actuator 38. For example, instead of the user physically rotating actuator 38 in a counter-clockwise direction to move clamp arms 18 farther from each other, the user may utilize the clamp arm release mechanism (such as by pressing on the clamp arm release mechanism) to cause the clamp arms 18 to move farther from each other (or to release the pressure that keeps the clamps arms 18 in the same position). As such, when the user desires to remove the deadbolt reinforcement device 10 from the door, the user may utilize the clamp arm release mechanism, causing clamp head 14 to no longer engage the deadbolt turnable handle. The clamp arm release mechanism may be activated (or otherwise released) using a button, a toggle switch, or any other device or mechanism for releasing the clamp arms 18 from a particular position.

Deadbolt reinforcement device 10 further includes a clamp head rotation member 42. Clamp head rotation member 42 is configured to couple clamp head 14 to shaft 46, and further configured to allow clamp head 14 to rotate with respect to shaft 46. In particular embodiments, clamp head rotation member 42 may allow a user to selectively rotate (or adjust) the angle of the clamp head 14 (and the clamp arms 18) so that deadbolt reinforcement device may reinforce any type of deadbolt. For example, deadbolts may be designed (or installed) in a manner that causes the deadbolt to be locked only when the deadbolt turnable handle is positioned at a particular angle, such as horizontal, vertical, or any angle in-between. As such, a first deadbolt may only be locked when the deadbolt turnable handle is positioned at a vertical angle, a second deadbolt may only be locked when the deadbolt turnable handle is positioned at a horizontal angle, and a third deadbolt may only be locked when the deadbolt turnable handle is positioned at an angle in-between horizontal and vertical (such as, for example, 45 degrees). Clamp head rotation member 42, in particular embodiments, may allow deadbolt reinforcement device 10 to be used with any deadbolts (and/or any deadbolt locking positions) because clamp head 14 may be rotated to accommodate any angle of the deadbolt turnable handle. As such, a user may be able to use deadbolt reinforcement device 10 on a particular deadbolt, even if the user does not have advance knowledge of the locking position required by that particular deadbolt.

Clamp head rotation member 42 may include any type of mechanism configured to allow clamp head 14 to rotate with respect to shaft 46. For example, clamp head rotation member 42 may include a ratcheting mechanism that allows rotation in one direction in small increments and that may prevent rotation in the opposite direction (unless the ratcheting mechanism is released or the direction of the ratcheting mechanism is switched). In such an example, the user may rotate clamp head 14 in a first direction (such as clockwise) to a position where clamp head 14 may engage with the deadbolt turnable handle, and the ratcheting mechanism may prevent the deadbolt turnable handle from rotating in the opposite direction (such as counter-clockwise). Furthermore, in such an example, the rotational direction of the ratcheting mechanism may be switched. As such, the user may rotate clamp head 14 in a second direction (such as counter-clockwise) to a position where clamp head 14 may engage with the deadbolt turnable handle, and the ratcheting mechanism may prevent the deadbolt turnable handle from rotating in the opposite direction (such as clockwise). As another example, clamp head rotation member 42 may include any other rotation mechanism (such as a movable cylinder, ball, or gear) that allows rotation in any direction (such as either clockwise or counter-clockwise). In such an example, the user may rotate clamp head 14 in any direction (such as either clockwise or counter-clockwise) to a position where clamp head 14 may engage with the deadbolt turnable handle, and the user may then enable an optional rotation locking mechanism (not shown) to prevent rotation in any direction (such as either clockwise or counter-clockwise). The optional rotation locking mechanism may be any type of mechanism that may prevent rotation, such as a spring-based (or pressure-based) element that prevents rotation of a gear, a brake-based system that applies pressure to a rotating cylinder, ball, or gear, any other type of rotation locking mechanism, or any combination of the preceding. Furthermore, the rotation locking mechanism may be used to lock the rotation of any type of clamp head rotation member 42. For example, when the clamp head rotation member 42 includes a ratcheting mechanism (which may normally allow rotation in one direction, and not in the opposite direction), the rotation locking mechanism may prevent rotation of such a ratcheting mechanism in any direction.

Clamp head rotation member 42 may allow for any amount of rotation of clamp head 14 with respect to shaft 46. For example, clamp head rotation member 42 may allow clamp head 14 to rotate 45 degrees with respect to shaft 46, 90 degrees with respect to shaft 46, 180 degrees with respect to shaft 46, 270 degrees with respect to shaft 46, 360 degrees with respect to shaft 46, or any amount in-between zero degrees and 360 degrees. In particular embodiments, the rotation of clamp head 14 with respect to shaft 46 may further allow deadbolt reinforcement device 10 to reinforce any arrangement of deadbolt/door handle configurations. For example, due to the rotation ability of clamp head 14, shaft 46 may be positioned to either the left side or the right side of the door handle. Therefore, no matter which rotation direction is used to unlock a deadbolt (i.e., clockwise or counter-clockwise), shaft 46 may engage with the door handle in a manner that prevents rotation of the deadbolt turnable handle in that direction, in particular embodiments.

Deadbolt reinforcement device 10 further includes shaft 46. Shaft 46 is configured to engage with a door handle of a door, and further configured to retain a deadbolt in a locked position on the door. For example, when a user positions shaft 46 up against the door handle of a door, a person outside of the door may no longer be able to unlock the deadbolt (even with a key in particular embodiments) because the door handle prevents the shaft from rotating past the door handle. In such an example, this rotation prevention force (from the door handle) is transferred from shaft 46 to clamp head 14, and further transferred from clamp head 14 to the deadbolt turnable handle. As such, in particular embodiments, a person outside of the door may no longer be able to unlock the deadbolt, even with a key.

Shaft 46 may have any suitable size and/or shape. For example, shaft 46 may have a longer length than width (i.e., elongate). As is illustrated, shaft 46 has a first end 50 and a second end 54. In particular embodiments, second end 54 may be optionally configured to extend away from (or retract toward) first end 50 to accommodate any arrangement of deadbolt/door handle configurations. For example, some doors may have a deadbolt that is positioned close to the door handle (such as positioned less than 11 inches away from each other), some doors may have a deadbolt that is positioned far from the door handle (such as positioned greater than 11 inches away from each other), and some doors may have a deadbolt that is positioned approximately 11 inches away from the door handle. In such an example, second end 54 may be configured to extend away from (or retract toward) first end 50 so that shaft 46 can have a length that is suitable for working with any range of distances in-between the deadbolt and the door handle of a door.

Second end 54 may extend away from (or retract toward) first end 50 in any suitable manner. For example, second end 54 may telescope away from (or retract toward) first end 50. In such an example, first end 50 may be at least partially hollow, and at least a portion of second end 54 may be positioned inside the hollow portion of first end 50. As another example, second end 54 may be a separate piece of shaft 46 that is attachable to shaft 46 when the user desires a longer shaft 46. As a further example, second end 54 may be coupled to first end 50 by a lockable hinging mechanism (not shown) that allows second end 54 to swing up and down in relation to first end 50.

Shaft 46 may further include a rotatable collar 58 configured to lock second end 54 into an extended or retracted position, or to move second end 54 into an extended or retracted position. For example, rotatable collar 58 may be a tightening mechanism that allows second end 54 to be locked in a particular position. In such an example, a user may first unlock the rotatable collar 58 (such as by twisting, for example), then extend or retract the second end 54 to a desired length, and then re-lock the rotatable collar 58 (such as by twisting in the opposite direction, for example). As another example, rotatable collar 58 may be a rotatable extension/retraction system. In such an example, the user may rotate the rotatable collar 58 in a first direction (such as clockwise) in order to extend the second end 54 to a desired length, and the user may rotate the rotatable collar 58 in the opposite direction (such as counter-clockwise) in order to retract the second end 54 to a desired length.

Shaft 46 may be formed of any suitable material, such as metal, a rigid plastic, or any combination of the preceding. Furthermore, shaft 46 (or one or more portions of shaft 46) may include protective coating or a protective sleeve (not shown). The coating or sleeve may be, for example, plastic, rubber, silicone, and/or foam, and may protect the door handle from scratches if the shaft 46 (or a portion thereof, such as second end 54) is knocked against the handle.

In an exemplary embodiment of operation, a user may desire to lock a deadbolt of an entry door (such as the entry door into a residential area or a hotel room) and may further desire to reinforce the locked deadbolt using the deadbolt reinforcement device 10. In order to do so, the user may lock the deadbolt by turning the deadbolt turnable handle to its locked position. Depending on the type of deadbolt lock and how it was installed, the deadbolt turnable handle may be required to be positioned in one of many different positions or angles, such as horizontal, vertical, or any angle in-between. Furthermore, the deadbolt turnable handle may have one of many different sizes and/or shapes, such as rectangular, oval, rhomboid, any other shape, or any combination of the preceding. Additionally, depending on the door style, the deadbolt and the door handle may have one of many different distances between each other, such as more than 11 inches, less than 11 inches, or 11 inches. In order to accommodate one or more of the above described deadbolt/door handle configurations (or any other configuration), the user may perform one of or more of the following example steps.

First, the user may optionally extend or retract the second end 54 of shaft 46 with respect to the first end 50 to accommodate a distance between the deadbolt of the door and the door handle of the door. For example, the user may telescopically extend or retract the second end 54 of the shaft 46 with respect to the first end 50. The user may extend or retract the second end 54 to any distance to accommodate any distance between the deadbolt of the door and the door handle. As such, the user may utilize the deadbolt reinforcement device 10 with any type of deadbolt/door handle configuration. The user may extend or retract the second end 54 in any suitable manner. For example, the user may rotate rotatable collar 58 in a first direction (such as clockwise) to extend the second end 54, and may rotate rotatable collar 58 in a second direction (such as counter-clockwise) to retract the second end 54. As another example, the user may rotate rotatable collar 58 in a first direction (such as clockwise) to lock the second end 54 in a particular position, and may rotate rotatable collar 58 in a second direction (such as counter-clockwise) to unlock the second end 54 from the particular position. As such, the user may extend or retract the second end 54 to any particular position, and then lock the second end 54 at that particular position.

Second, the user may position the second end 54 of the shaft 46 to engage with the door handle of the door. For example, if the deadlock turnable handle unlocks the deadbolt by turning in a clockwise motion, the second end 54 may be positioned to the right side of the door handle. In such an example, such a positioning may prevent the deadlock turnable handle from turning in a clockwise motion, thereby reinforcing the deadlock. As another example, if the deadlock turnable handle unlocks the deadbolt by turning in a counter-clockwise motion, the second end 54 may be positioned to the left side of the door handle. In such an example, such a positioning may prevent the deadlock turnable handle from turning in a counter-clockwise motion, thereby reinforcing the deadlock. As another example, second end 54 may be configured with an inverted “U” shape that is designed to engage with both sides of the door handle. In such an example, the second end 54 may be positioned on both sides of the door handle, preventing the deadbolt turnable handle from being turned in either a clockwise motion or a counter-clockwise motion, thereby reinforcing the deadlock.

Third, the user may rotate the clamp head 14 in a first direction with respect to the shaft 46 so that first clamp arm 18a and second clamp arm 18b are substantially parallel to a deadbolt turnable handle of the deadbolt in a locked position. For example, if the deadbolt turnable handle is in a locked position when it is horizontal, the user may rotate the clamp head 14 in a first direction with respect to the shaft 46 so that first clamp arm 18a and second clamp arm 18b are substantially horizontal. This may allow the user to slide (or otherwise position) the clamp arms 18 over the deadbolt turnable handle, as is discussed below. Furthermore, by rotating the clamp head 14, the user may be able to utilize the deadbolt reinforcement device 10 with a deadbolt that has any type of locked position, such as horizontal, vertical, or any angle in-between. Additionally, as is discussed above, the clamp head 14 may be selectively rotatable with respect to shaft 46. For example, a locking mechanism or a ratcheting mechanism may prevent the clamp head 14 from rotating in any direction (or in a particular direction, such as the direction that unlocks the deadbolt) when the user desires to prevent such a movement.

Fourth, the user may position the first clamp arm 18a to a first side of the deadbolt turnable handle in the locked position and the second clamp arm 18b to a second side of the deadbolt turnable handle in the locked position. For example, as a result of the first clamp arm 18a and the second clamp arm 18b being substantially parallel to the deadbolt turnable handle, the user may slide the first clamp arm 18a and the second clamp arm 18b over the deadbolt turnable handle. In such an example, the clamp arms may be positioned on opposite sides of the deadbolt turnable handle (as is seen in FIG. 1C), thereby allowing the clamp arms 18 to grip the deadbolt turnable handle when the clamps arms 18 are moved toward each other.

Fifth, the user may activate the actuator 38 to move the first clamp arm 18a toward the second clamp arm 18b to grip the deadbolt turnable handle. As is discussed above, actuator 38 may be activated in any suitable manner, such as by a user physically rotating actuator 38 in a particular direction, a user squeezing actuator 38 together (e.g., when actuator 38 is two or more grips), a user pressing a button, a user activating a switch, or any other means of activating actuator 38. As a result of activating actuator 38, first clamp arm 18a may grip the deadbolt turnable handle, preventing it from being unlocked. Furthermore, as is discussed above, clamp arms 18 may have compressible engagement surfaces 34 that may further allow clamp arms 18 to securely grip the deadbolt turnable handle. In particular embodiments, compressible engagement surfaces 34 may compress (or otherwise deform) to any shape of the deadbolt turnable handle, such as a rectangular shape, oval shape, rhomboid shape, any other shape, or any combination of the preceding. As such, compressible engagement surfaces 34 may be capable of securely gripping any type of deadbolt turnable handles, regardless of shape and/or size, thereby allowing the user to utilize the deadbolt reinforcement device 10 with any type of deadbolt configuration.

As a result of performing the above described steps, in particular embodiments, deadbolt reinforcement device 10 may be capable of reinforcing any type of deadbolt. Additionally, one or more of the above described steps may be performed in any suitable order and/or may be performed in parallel to one or more other steps. Furthermore, one or more of the above-referenced steps may be performed in reverse in order to remove deadbolt reinforcement device 10 from the door and deadbolt it is reinforcing. Also, one or more of the above-referenced steps may not be performed. For example, the user may not extend nor retract the second end 54 of shaft 46 with respect to the first end 50 to accommodate a distance between the deadbolt of the door and the door handle of the door. Furthermore, although the above-referenced steps have been discussed above as being performed using deadbolt reinforcement device 10, in particular embodiments, one or more (or all) of the above-referenced steps may be performed using any other suitable device. For example, one or more (or all) of the above-referenced steps may be performed using any suitable device that includes a shaft, a rotatable clamp head with clamp arms, and an actuator that may move a first clamp arm toward a second clamp arm.

This specification has been written with reference to various non-limiting and non-exhaustive embodiments. However, it will be recognized by persons having ordinary skill in the art that various substitutions, modifications, or combinations of any of the disclosed embodiments (or portions thereof) may be made within the scope of this specification. Thus, it is contemplated and understood that this specification supports additional embodiments not expressly set forth in this specification. Such embodiments may be obtained, for example, by combining, modifying, or reorganizing any of the disclosed steps, components, elements, features, aspects, characteristics, limitations, and the like, of the various non-limiting and non-exhaustive embodiments described in this specification. In this manner, Applicant reserves the right to amend the claims during prosecution to add features as variously described in this specification, and such amendments comply with the requirements of 35 U.S.C. §§112(a) and 132(a).

1. A deadbolt reinforcement device comprising:
an elongate shaft having a first end and a second end, the first end being at least partially hollow, wherein at least a portion of the second end is positioned within the hollow portion of the first end;
a clamp head coupled to the first end of the shaft and comprising a first clamp arm and a second clamp arm, the first clamp arm and the second clamp arm having rigid portions and compressible engagement surfaces positioned on the rigid portions, the clamp head being selectively rotatable with respect to the shaft, the compressible engagement surfaces comprising at least one of the following materials:
rubber;
silicone; and
foam;
a clamp head rotation member configured to rotatably couple the clamp head to the shaft, the clamp head rotation member providing a lockable two-way rotation of the clamp head for 360 degrees with respect to the shaft; and
an actuator operatively coupled to the clamp head, the actuator configured to move the first clamp arm toward the second clamp arm to grip a deadbolt turnable handle between the compressible engagement surfaces, wherein the actuator is rotatable to ratchet the first clamp arm toward the second clamp arm and is configured to be oriented towards a user when the clamp head is positioned for engagement with the deadbolt turnable handle; and
wherein the second end of the shaft is telescopically extendable to accommodate a plurality of different deadbolt/door handle configurations.

2. A deadbolt reinforcement device comprising:
an elongate shaft having a first end and a second end;
a clamp head coupled to the first end of the shaft and comprising a first clamp arm and a second clamp arm, the first clamp arm and the second clamp arm having compressible engagement surfaces, the clamp head being selectively rotatable with respect to the shaft; and
an actuator operatively coupled to the clamp head, the actuator configured to move the first clamp arm toward the second clamp arm to grip a deadbolt turnable handle between the compressible engagement surfaces.

3. The deadbolt reinforcement device according to claim 2, wherein the actuator is rotatable to ratchet the first clamp arm toward the second clamp arm and is configured to be oriented towards a user when the clamp head is positioned for engagement with the deadbolt turnable handle.

4. The deadbolt reinforcement device according to claim 3, wherein the actuator comprises a lever or knob.

5. The deadbolt reinforcement device according to claim 2, wherein the actuator comprises a first grip and a second grip, wherein the first grip is configured to be moved toward the second grip to move the first clamp arm toward the second clamp arm.

6. The deadbolt reinforcement device according to claim 2, further comprising a clamp head rotation member configured to rotatably couple the clamp head to the shaft, the clamp head rotation member providing a lockable two-way rotation of the clamp head with respect to the shaft.

7. The deadbolt reinforcement device according to claim 2, wherein the clamp head is selectively rotatable for 360 degrees with respect to the shaft.

8. The deadbolt reinforcement device according to claim 2, further comprising a rotation locking mechanism configured to selectively lock the rotation of the clamp head with respect to the shaft.

9. The deadbolt reinforcement device according to claim 2, wherein the second end of the shaft is extendable to accommodate a plurality of different deadbolt/door handle configurations.

10. The deadbolt reinforcement device according to claim 9, wherein the second end of the shaft is configured to telescopically extend away from and retract toward the first end of the shaft.

11. The deadbolt reinforcement device according to claim 2, wherein the compressible engagement surfaces comprise at least one of the following materials:
rubber;
silicone; and
foam.

12. A method of reinforcing a deadbolt, comprising:
positioning a second end of a shaft of a deadbolt reinforcement device to engage with a door handle of a door;
rotating a clamp head of the deadbolt reinforcement device in a first direction of the clamp head with respect to the shaft so that a first clamp arm of the clamp head and a second clamp arm of the clamp head are substantially parallel to a deadbolt turnable handle of a deadbolt of the door in a locked position, wherein the clamp head is locked from rotating with respect to the shaft in at least an opposite direction of the first direction of the clamp head, wherein the first clamp arm and the second clamp each have a compressible engagement surface;
positioning the first clamp arm on a first side of the deadbolt turnable handle in the locked position and the second clamp arm on a second side of the deadbolt turnable handle in the locked position; and
rotating an actuator of the deadbolt reinforcement device in a first direction of the actuator to move the first clamp arm toward the second clamp arm to grip the deadbolt turnable handle between the compressible engagement surfaces.

13. The method according to claim 12, wherein the actuator is rotatable to ratchet the first clamp arm toward the second clamp arm and is configured to be oriented towards a user when the clamp head is positioned for engagement with the deadbolt turnable handle.

14. The method according to claim 13, wherein the actuator comprises a lever or knob.

15. The method according to claim 12, wherein the deadbolt reinforcement device provides for a lockable two-way rotation of the clamp head with respect to the shaft.

16. The method according to claim 12, wherein the clamp head is selectively rotatable for 360 degrees with respect to the shaft.

17. The method according to claim 12, further comprising extending or retracting the second end of the shaft with respect to a first end of the shaft to accommodate a distance between the deadbolt of the door and the door handle of the door.

18. The method according to claim 17, further comprising telescopically extending or retracting the second end of the shaft with respect to the first end of the shaft to accommodate the distance between the deadbolt of the door and the door handle of the door.

19. The method according to claim 17, further comprising rotating a rotatable collar in a first direction of the rotatable collar in order to lock the second end of the shaft in a position with respect to the first end of the shaft or rotating the rotatable collar in a second direction of the rotatable collar in order to unlock the second end of the shaft from the position with respect to the first end of the shaft.

20. The method according to claim 12, wherein the compressible engagement surfaces comprise at least one of the following materials:
rubber;
silicone; and
foam.
